(19) United States
(12) Patent Application Publication
(10) Pub. No.: US 2016/0004748 A1
(43) Pub. Date: Jan. 7, 2016

(54) GENERATING LOCALIZED NAME PRONUNCIATION

(71) Applicant: GOOGLE INC., Mountain View, CA (US)

(72) Inventor: Ralf Botchen, Belo Horizonte (BR)

(21) Appl. No.: 14/321,368

(22) Filed: Jul. 1, 2014

(51) Int. Cl. G06F 17/30

(52) U.S. Cl. CPC G06F 17/30477; G06F 17/30241; G06F 17/30023

(57) ABSTRACT

A multimedia content search module operating in a server device provides localized pronunciations of names for social networking participants. When a participant signs up for a social networking service, the participant creates a social networking profile by inputting personal information such as name as well as geographic information, i.e., a birthplace, place of residence, etc. The server device then determines a pronunciation of the name by searching multimedia content from the participant's geographic region of origin for an instance of the name. The pronunciation is then stored in the participant's social networking profile and provided in response to a request by a user for pronunciation of the social networking participant's name.

### FIELD OF THE DISCLOSURE

The present disclosure relates to digital mapping data and, more particularly, to determining correctly pronounced names based on location in a social networking environment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, software application executing in computing, smartphone, etc., or embedded devices display user profiles for social networks. The user profiles may include a user's name, age, birthplace and/or place of residence. In some cases, the software applications may also display a photograph of the user.

### SUMMARY

A multimedia content search module in a server device automatically provides a pronunciation of the name of a participant in a social network in view of the participant's profile, particularly his or her place of origin. The server can construct and maintain a knowledge repository that includes pronunciations of names for various geographic regions. For a certain participant, the system finds the closest match between the participant's country/region/city of origin and one of the locations in the knowledge repository for which a pronunciation is available. The participant also can override the automatically determined pronunciation.

When determining how a certain name is pronounced for a certain region, the multimedia content search module can search through various types of multimedia content to determine whether there are reliable examples of the name being vocalized. For example, when searching for an already-pronounced instance of the name “Jackie” for the United States, the system can identify the film “Jackie Brown” and locate an audio announcement of this title or a reference to the title in an audio file.

More generally, the multimedia content search module can use various types of contextual information to determine how a name or word should be localized for the purposes of pronunciation, and search through various types of multimedia content, such as songs, audiobooks, etc. for examples of proper pronunciation.

In particular, an example embodiment of the techniques of the present disclosure is a method for generating localized pronunciations of names. The method includes receiving a name of a social networking participant and an indication of a geographic region of origin of the social networking participant and identifying multimedia content that includes an instance of the name vocalized at least near the geographic region of origin. The method further includes storing a reference to the vocalized name in a database record associated with the social networking participant on a computer readable medium, and providing the vocalized name in response to a request for pronunciation of the social network participant's name.

Another embodiment of these techniques is a computing device including a machine-readable knowledge repository in which data that describes attributes of entities is organized according to semantic relations between the entities, each entity corresponding to a geographic region and a name and having a reference related to a vocalized instance of the name. The computing device also includes one or more processors, and a non-transitory computer-readable memory storing thereon instructions. When executed by the one or more processors, the instructions cause the computing device to receive a name of a social networking participant and an indication of a geographic region of origin of the social networking participant, and identify multimedia content that includes an instance of the name vocalized at least near the geographic region of origin. The instructions further cause the computing device to store a reference to the vocalized name in a database record of the machine-readable knowledge repository associated with the social networking participant and provide the vocalized name in response to a request for pronunciation of the social networking participant's name.

Yet another embodiment of these techniques is a client device including an audio speaker, and a user interface including a user control for requesting pronunciation of a name displayed on the user interface. The client device further includes one or more processors coupled to the audio speaker and the user interface and a non-transitory computer-readable memory coupled to the one or more processors and storing thereon instructions. When executed by the one or more processors, the instructions cause the client device to transmit a name of a social networking participant and a request for pronunciation of the name of the social networking participant, via the user control, to a server device. The instructions further cause the client device to obtain an instance of the name vocalized at least near a geographic region of origin of the social networking participant from the server device and to provide the vocalized name via the audio speaker.

### BRIEF DESCRIPTION OF THE DRAWINGS

FIG. 1 illustrates a block diagram of an example communication system in which techniques for generating localized pronunciation of names can be implemented;

FIG. 2 illustrates an example knowledge repository which stores vocalized names for various geographic regions;

FIG. 3 illustrates an example user interface which displays a social networking profile including a user control for requesting pronunciation of a name; and

FIG. 4 is a flow diagram of an example method for generating localized pronunciation of names at a server device.

### DETAILED DESCRIPTION

### Overview

Generally speaking, techniques for generating localized pronunciation of names can be implemented in a multimedia content search module operating in a portable computing device, a wearable device, a non-portable computing device, one or several network servers, or a system that includes a combination of these devices. Names can be pronounced for a social networking profile, for a name in the “to:” line of an email, for participants in a calendar invite, for a user's contacts/address book, etc. However, for clarity, the examples below focus primarily on an embodiment in which a social networking participant creates a social networking profile containing her name, age, birthplace, place of residence, etc., on a computing device. A server device receives and stores the social networking profile information. Moreover, a multimedia content search module operating in the server device then searches a knowledge repository, also stored at the server device or another server, for a localized pronunciation of the name of the social networking participant based on the social networking participant's birthplace, place of residence, etc. When the multimedia content search module identifies a localized pronunciation of the name in the knowledge repository, the pronunciation may be stored with the social networking profile. Otherwise, various types of multimedia content such as music, video, audiobooks, movies, television, voice recordings, etc., are searched to find a localized pronunciation of the name and store the pronunciation in the knowledge repository and/or the social networking profile. Further, the social networking participant can override the localized pronunciation by pronouncing her name herself. The pronunciation is then received at the server and can be stored in the knowledge repository and/or her social networking profile.

Moreover, when a user of a portable device (also referred to herein as a “client device”) requests pronunciation of the social networking participant's name, the localized pronunciation of the name stored in the knowledge repository and/or the social networking profile is provided to the portable device.

For clarity, the term “social networking participant” is used when referring to a person who creates and/or maintains a social networking profile. While a “social networking participant” can be a user of a client device, the term “user” is used when referring to a person viewing a social networking profile of a social networking participant so as to avoid confusion.

### Example Hardware And Software Components

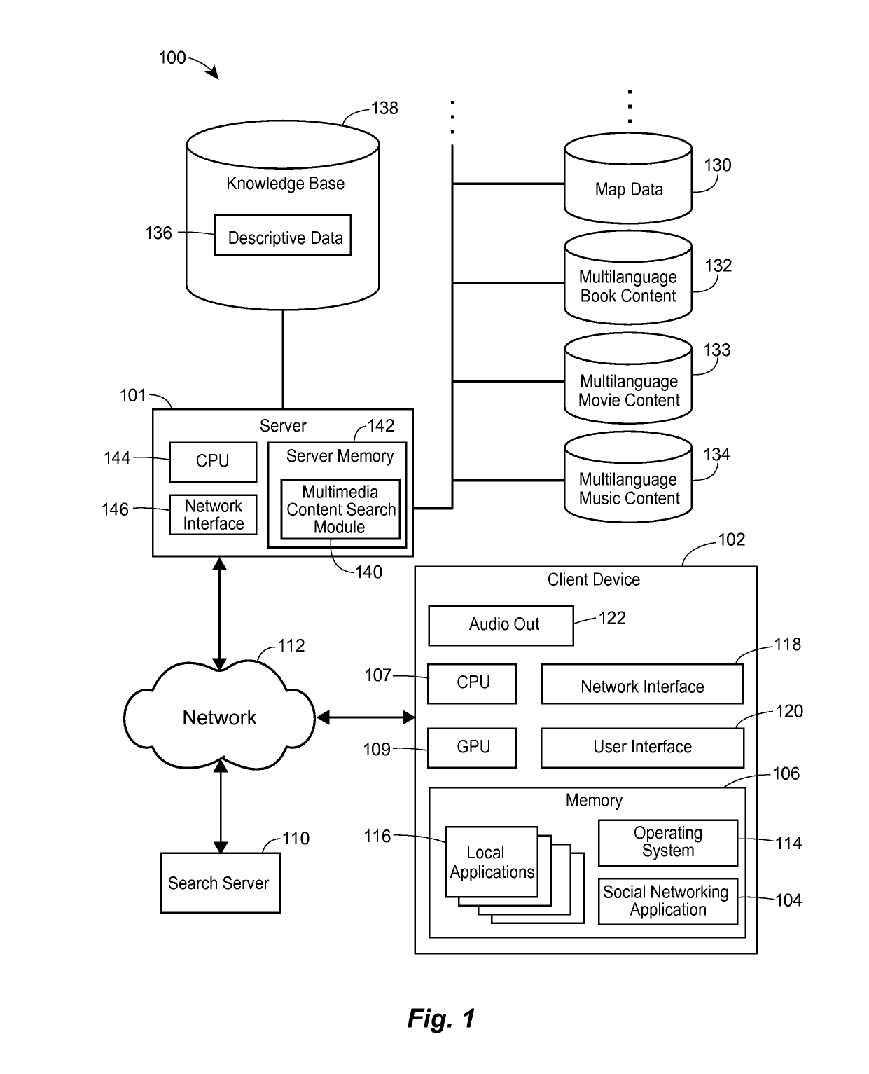

Referring to FIG. 1, an example computing environment 100 in which the techniques outlined above can be implemented includes a client device 102, a server 101, and a search server 110. The client device 102 can display social networking profiles in a social networking application 104, which is stored in the memory 106 as a set of instructions and executes on one or more processor(s) (CPU) 107 and/or a graphics processing unit (GPU) 109. The social networking application 104 in general can display social networking profiles supplied by the server 101 via a network 112, which can be a wired or wireless network including any suitable local or wide area network (e.g., the Internet). For example, the social networking application 104 may be a special-purpose application available at an online application store disposed at the server 101 or an application server (e.g., Google+™). A user of the client device 102 may retrieve a copy of the social networking application 104 from the application server and install the retrieved copy of the mapping application on the client device 102. In other implementations, the social networking application 104 can be a software component, such as a plug-in, that operates in a web browser (e.g., Google Chrome® or Apple's Safari®) or another application.

The memory 106 may be a tangible, non-transitory memory and may include any types of suitable memory modules, including random access memory (RAM), read-only memory (ROM), a hard disk drive, flash memory, or other types of memory. In addition to the social networking application 104, the memory stores an operating system (OS) 114 and one or more local application(s) 116 or modules. The operating system 114 may be any type of suitable operating system. The one or more local application(s) 116 may include a variety of installed applications including contacts/address book for a user. In this manner, the local application(s) 116 may store localized pronunciations of names for a user's contacts using the techniques described below, for example, in the user's address book. The applications 116 and the social networking application 104 can receive digital content via a network interface 118. A user can interact with the applications 104 and 116 via a user interface 120, which can include a touchscreen, a screen along with speakers 122, a keyboard and a mouse, a microphone, a camera, a global positioning system (GPS) sensor, a WiFi module, etc.

In general, the client device 102 can be any suitable portable or non-portable computing device. By way of example, the client device 102 may be a smartphone, a tablet computer, a laptop computer, a wearable computing device, etc. In various implementations, the client device 102 can include fewer components than illustrated in FIG. 1 or conversely, additional components. In some implementations, for example, the client device 102 may include multiple instances of the CPU 107. For clarity, the client device 102 may be operated by a user who views social networking profiles. Social networking participants who create and/or maintain social networking profiles may create the profiles on another computing device (not shown). As a result, the server 101 receives and subsequently stores social networking profile information from the other computing device (not shown), and provides the social networking profile to the client device 102 for a user to see. The server 101 nay also receive and subsequently store additional contact information associated with an email address, and when the user types the email address in the “to:” line of an email, the server 101 may provide the additional contact information which may include a pronunciation of the name associated with the email address.

The server 101, from which the client device 102 receives social networking profiles including localized name pronunciations, may be communicatively coupled to multiple databases such as (i) a map database 130 storing map data that can include street and road information, topographic data, satellite imagery, information related to public transport routes, information about businesses or other points of interest (POIs), information about current traffic conditions, etc., (ii) a multi-language book content database 132 storing an international collection of books, and audio-books, (iii) a multi-language movie content database 133 storing an international collection of movies in the public domain including movies in several languages, and (iv) a multi-language music content database 134 storing an international collection of music including lyrics and audio in the public domain including translations to several languages. The map data can be stored in the map database 130 in a vector graphics format, a raster format, or both. In general, the server 101 can receive information about geographically related objects from any number of suitable databases, web services, etc.

It will be understood that although the server is illustrated in FIG. 1 as a single device, in general the server 101 can correspond to multiple servers responsible for respective types of content or respective operations. For example, the server 101 can include a server that stores social networking profiles and another server that searches multimedia content for localized pronunciations of names. For example, a search server 110 may search multimedia content after the server 101 does not identify a localized version of a name in a database. The search server 110 may search the Internet or any other machine-readable source of information for multimedia content in the public domain which includes a pronunciation of the social networking participant's name. The search server 110 may then provide the pronunciation in the form of an audio file, a video file, etc., to the server 101 which in turn may store the pronunciation with the participant's social networking profile.

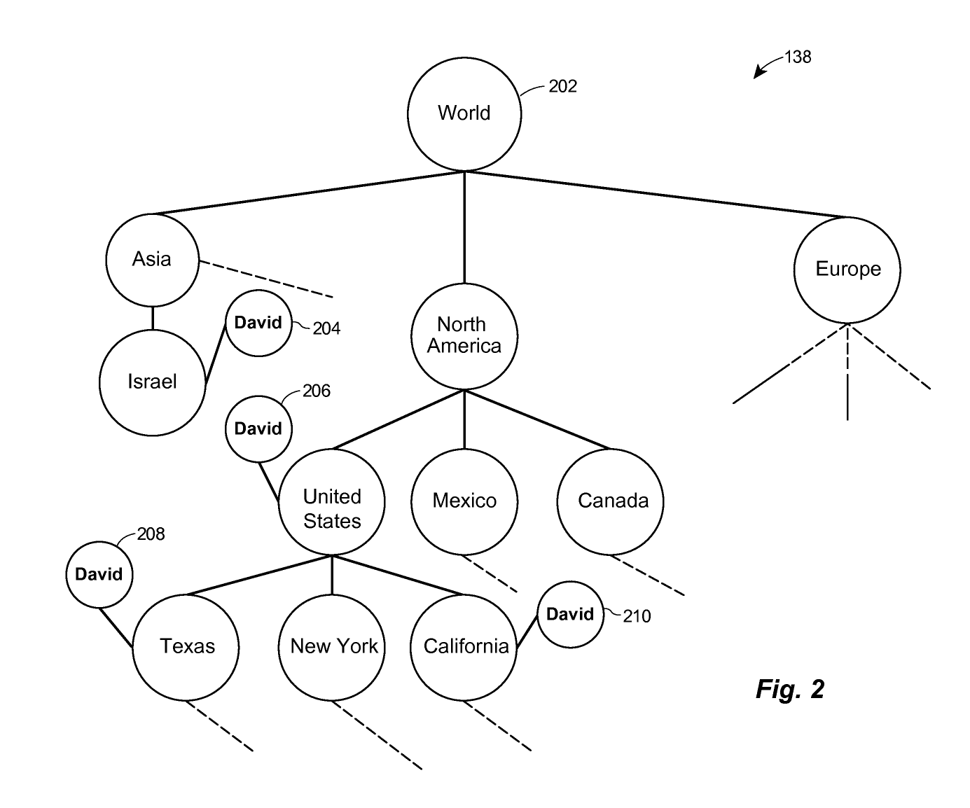

In addition to the databases 130, 132, 133, and 134, the server 101 may be communicatively connected to a knowledge base 138. The knowledge base 138 is a machine-readable repository of data or information about geographic entities (e.g., objects of interest, places, etc.) organized around semantic principles. By way of example, semantic principles may include geographic relationships (e.g., city, country, etc.). The data or information about entities may include descriptive data 136 (text descriptions, audio narration such as pronunciation of names, etc.). The descriptive data 136 can include “knowledge cards” for various entities that specify various facts, links to additional information, links to audio narrations, etc. For example, when the entity represents a name such as “Justin” that is connected to an entity representing the United States, the associated “knowledge card” may include a link to an American pronunciation of the name “Justin,” in an audio and/or video file. In some embodiments, the “knowledge cards” may include links to text translations of names to their respective native languages and/or alphabets. Although the knowledge base 138 is shown in FIG. 1 as storing the descriptive data 136, some knowledge bases may be purely organizational databases in which relationships, or connections, between entities are defined, without storing specific digital content related to the entities. An example knowledge base 138 is described in further detail below with reference to FIG. 2.

In the illustrated implementation, the system for generating localized pronunciations of names includes a multimedia content search module 140 (also referred to herein as “the module”) stored in a server memory 142 and executed by the server CPU 144. The module 140 may generate local pronunciations of names using geographic context from a social networking participant and related information in the knowledge base 138. For example, the social networking participant may input her birthplace or place of residence on a computing device when creating her social networking profile which is received at the server 101 and used as geographic context. In some embodiments, the server 101 may receive the social networking participant's current location based on the global positioning system (GPS) location of the social networking participant's computing device. In this case, the current location may be used as geographic context. In other embodiments, the social networking participant may be prompted to provide the geographic origin of her name when creating a social networking profile or setting up an email address. However, these are merely a few examples in which the module 140 may receive geographic context for the social networking participant. Geographic context for the social networking participant may be received in any suitable manner. Moreover, the techniques for providing localized pronunciations of names are not limited to names received from a social networking profile. The techniques mentioned above and described in more detail below can be applied for a name in the “to:” line of an email, for participants in a calendar invite, for a user's contacts/address book, etc.

Turning now to FIG. 2, an example knowledge base 138 organizes connections between entities. As mentioned above, the knowledge base may be stored at the server 101 or any other suitable server. In FIG. 2, entities (such as people, places, etc.) are represented by circles and connections between entities are represented by lines connecting the circles. For example, the entity 202 represents the “World.” The example entity 202 is connected to other geographic locations based on a common geographic area. For example, the continents “Asia,” “North America” and “Europe” are connected to the “World.” Moreover, geographic location entities are connected to entities which represent names. Each name may have a geographic origin that is common to the geographic location that the name is connected with. For example, the name “David” 204 may have a geographic origin in Israel. The name “David” 206 may also have a geographic origin in the United States, and may be pronounced differently depending on the country of origin. For example, the Hebrew name “David” may be pronounced as dah-veed. On the other hand, the English version of the name “David” may be pronounced as day-vihd. Each entity which represents a name may include a text description of the name including a phonetic spelling of the name using, for example, the international phonetic alphabet as well as a video or audio file which includes a pronunciation of the name.

Moreover, the knowledge base 138 may include additional pronunciations for regional dialects. For example, the name “David” may be pronounced differently in Texas 208 than in California 210, and both pronunciations may be different than the pronunciation for the United States 206. In some embodiments, multiple pronunciations may be stored in the knowledge base 328 for a particular name connected with a geographic location. For example, one pronunciation may be from one form of multimedia content such as music, whereas another pronunciation may be from a second form of multimedia content such as television. Additionally, yet another pronunciation may be from a social networking participant. In some instances, the pronunciations may have associated priorities. For example, the pronunciation from the social networking participant may take priority over the multimedia content pronunciation(s).

To build the knowledge base 138, the server 101 may connect the entities by geographic location based on level of detail. For example, continents are connected to the world, countries are connected to continents, states and/or cities are connected to countries, etc. When a social networking participant creates a social networking profile and inputs his name and birthplace, the multimedia content search module 140 searches the knowledge base 138 for the specified name at the participant's birthplace and at a corresponding level of detail. For example, if the participant's name is David and he inputs his birthplace as “United States,” the module 140 will find entity 206. On the other hand, if David inputs his birthplace as “California,” the module will find entity 210. If the participant's name is Bill from New York, the knowledge base 138 will not identify a match, and as a result the module 140 will search multimedia content for a local pronunciation of Bill, as described in more detail below. When the module 140 finds a match, the name and pronunciation of Bill may be stored in the knowledge base 138 and connected to the entity “New York.”

While the knowledge base 138 is depicted in FIG. 2 as a tree structure this is merely an exemplary embodiment. The knowledge base 138 may be organized in any suitable structure and the entities in the knowledge base 138 may be connected in any suitable manner. Moreover, the entities are not limited to geographic locations, names and pronunciations of names as illustrated in the exemplary embodiment of FIG. 2. The entities may also include people, places, objects, etc. Additionally, while the knowledge base 138 stores a small number of geographic locations, this is for ease of illustration only. The knowledge base 138 may display any number of continents, countries, states, cities, etc., and corresponding names and pronunciations of names for each of them. Further, while the knowledge base 138 stores different pronunciations of one name (David), the knowledge base 138 may store pronunciations of thousands of names, millions of names or any suitable number of names. The knowledge base 138 can also store surnames as well as given names and can either store the surnames separately from the given names or together with given names.

In an exemplary scenario, John Doe has a business meeting with Nikolai Sokolov and does not know how to pronounce his name. John may search for Nikolai using a social networking application on a portable computing device and may find his profile page. The profile page may include a selectable user control, which when selected pronounces Nikolai's name. The pronunciation may come from Nikolai or from multimedia media content in the native language for the name Nikolai (e.g., Russian). After selecting the user control, John Doe may learn the proper pronunciation of Nikolai Sokolov and save himself the embarrassment of pronouncing the name incorrectly.

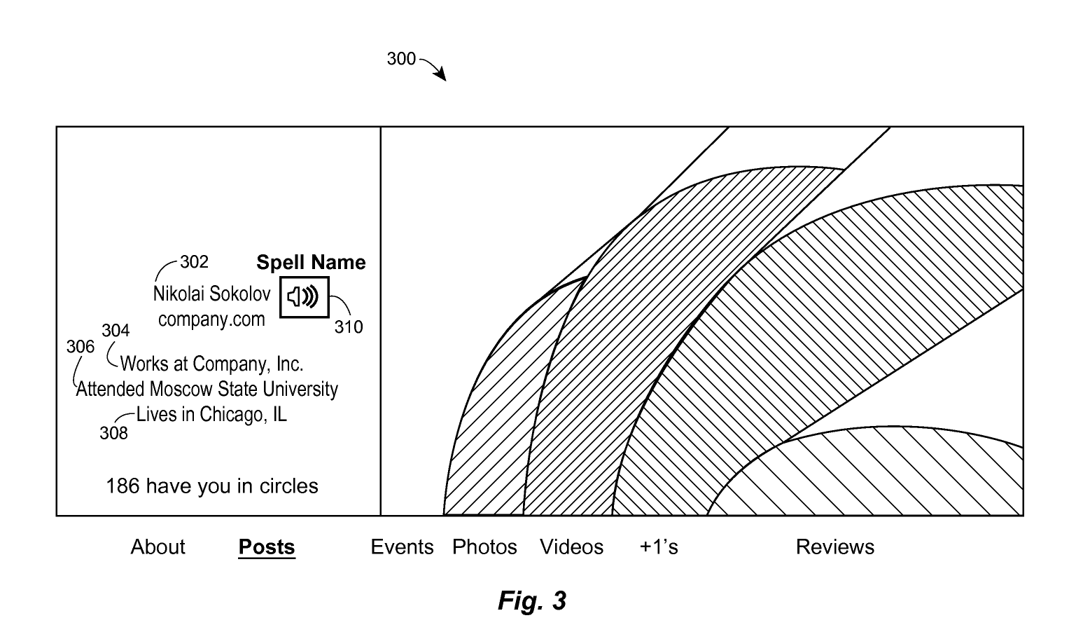

An example user interface 300 which displays a social networking profile for Nikolai Sokolov is illustrated in FIG. 3. The user interface 300 may display personal information for the social networking participant such as the participant's name 302, employer 304, college/university 306, and current place of residence 308. The user interface 300 may also display other personal or biographical information for the social networking participant such as his birthplace, age, a photograph, etc. The user interface 300 may be displayed on the client device 102 of FIG. 1, in response to a search query for “Nikolai Sokolov” using the social networking application 104.

Before Nikolai's social networking profile can be displayed on the user interface 300, he must create the profile by inputting biographical information (e.g., by using a social networking application on his computing device) which is then stored at the server 101. This biographical information may include his name as well as geographic information such as his birthplace, place of residence, etc. Nikolai may also permit the GPS location of his computing device to be transmitted to the server 101, and/or may input the geographic region of origin for his name.

When Nikolai's social networking profile is created, when a user enters Nikolai's email address in the “to:” line of an email, when the user stores Nikolai's name as a contact in an address book, or when Nikolai is listed as a participant in a calendar invite, the multimedia content search module 140 may access the knowledge base 138 and search for an instance of his name connected with the provided geographic information or a geographic location near the provided geographic information. In some embodiments, the search may depend on the level of detail provided in the geographic information. For example, if Nikolai listed his birthplace as “Russia,” the module 140 may search for an instance of the name Nikolai connected with “Russia.” On the other hand, if Nikolai listed his birthplace as “St. Petersburg, Russia,” the module may search for instances of the name Nikolai connected with “St. Petersburg.” Also in some embodiments, the multimedia content search module 140 may specify a maximum level of detail for performing the search. For example, if the social networking participant inputs his birthplace using latitude-longitude coordinates, and the maximum level of detail is a town, the module 140 may search for his name connected with the town encompassing the specified latitude-longitude coordinates.

If the name connected with the provided geographic information or connected with a geographic location near the provided geographic information is identified, the module 140 may store the associated pronunciation of the name from the knowledge base 138 in Nikolai's social networking profile. The module 140 may search the knowledge base 138 separately for instances of first and last names, such as “Nikolai” and “Sokolov,” and store the separate pronunciations together in the social networking profile, in the user's contacts/address book, or another suitable location. Then, when a client device user clicks on the speaker button 310 on the user interface 300 or another user interface, the stored pronunciation may be transmitted to the client device 102 and provided to the user via the speakers 122. In other embodiments, the server 101 may access the knowledge base 138 and transmit the pronunciation directly from the knowledge base 138 to the client device 102.

On the other hand, when the module 140 does not identify an instance of the name “Nikolai” connected with the provided geographic information, the multimedia content search module 140 searches multimedia content to identify a localized pronunciation of the name. To perform the search, the module 140 may search a multi-language book database 132, which may include an international collection of books, audio-books, or portions of books from the public domain as well as translations to several languages. The module 140 may search the book database 132 to find an instance of the name “Nikolai” in a book and/or may search a multi-language music database 134, which may include an international collection of music including lyrics and audio for music lyrics translated into English from Russian. In this manner, the module 140 can find the Russian spelling of the name in the Cyrillic alphabet. The Russian spelling may then be used to search a multi-language movie database 133, which includes an international collection of movies or portions of movies from the public domain in several languages. The module 140 may search the movie database 133 to identify a Russian pronunciation of the name “Nikolai.” If the geographic information includes further detail, such as St. Petersburg, Russia, the module 140 may search the movie database 133, for example, for movies shot in St. Petersburg and/or movies which take place in St. Petersburg in order to identify a pronunciation of the name “Nikolai” in a St. Petersburg dialect. Moreover, the module 140 may also search other multimedia content which may be in the public domain such as music, videos, audiobooks, television, voice recordings, etc., for instances of the name “Nikolai” pronounced in Russian.

In some embodiments, the module 140 may instead direct the search server 110 in FIG. 1 to search the other multimedia content. The search server 110 may search the Internet or any other machine-readable source of information for multimedia content in the public domain which includes a localized pronunciation of the social networking participant's name. When a localized pronunciation of the name is identified, the module 140 may store the pronunciation in the form of an audio file, a video file, etc., in the knowledge base 138 as an entity connected to the provided geographic location. Moreover, the pronunciation may be stored in Nikolai's social networking profile at the server 101, in the user's contacts/address book, or another suitable location.

In addition, the social networking participant may override the stored pronunciation by inputting a pronunciation of his name to the social networking application on his computing device, i.e., via a microphone. The pronunciation by the social networking participant may be stored in the social networking profile replacing the automatically determined pronunciation. In some embodiments, the social networking participant's pronunciation may also be stored in the knowledge base 138. Also in some embodiments, both the participant's pronunciation and the automatically determined pronunciation may be stored in the knowledge base and/or with the social networking profile. The participant's pronunciation may be associated with a higher priority and may be provided to a client device when a user requests pronunciation of the name. For example, Nikolai may select the speaker button 310 for his own social networking profile and determine that his name is pronounced differently than the conventional Russian pronunciation. He may then input his own pronunciation into the social networking profile which can be stored and provided when a user selects the speaker button 310.

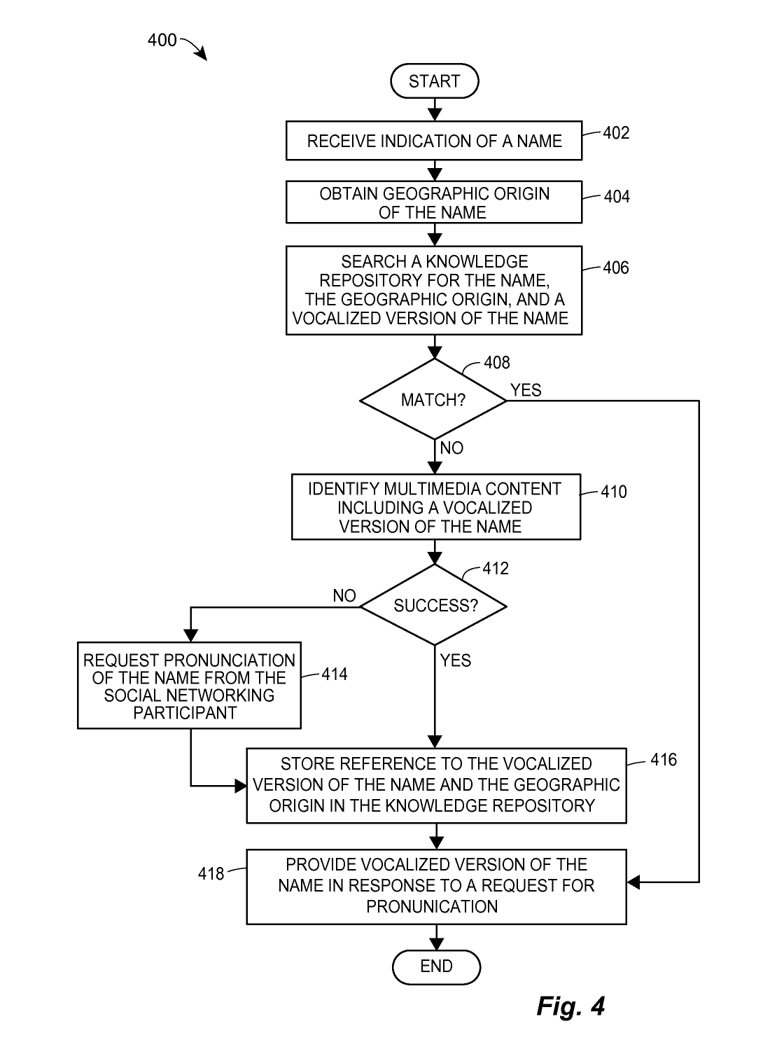

FIG. 4 illustrates a flow diagram of an example method 400 for generating localized pronunciation of names at the server device 101 of FIG. 1. At block 402, the server device 101 receives an indication of a name. The name may be received from a computing device of a social networking participant creating and/or editing a social networking profile. However, the techniques for providing localized pronunciations of names are not limited to names received from a social networking profile. The techniques mentioned above can be applied for a name in the “to:” line of an email, for participants in a calendar invite, for a user's contacts/address book, etc. In any event, at block 404 a geographic origin of the name is obtained by the server device 101. For example, the server 101 may obtain the networking participant's birthplace, place of residence, current location, etc. Moreover, the geographic origin may be obtained at varying levels of detail. For example, the server 101 may obtain a city, a state, a country, a region, latitude-longitude coordinates, etc.

Once a name and geographic origin of the name are obtained, the server 101 searches a knowledge repository for an entity including the name which is connected with the geographic origin of the name and a pronunciation of the name (block 406). The knowledge repository may be searched based on the level of detail of the geographic origin. For example, if the geographic origin is a continent, the server 101 may search the knowledge repository for any instance of the name connected with the continent. On the other hand, if the geographic origin is a town, the server 101 may instead search the knowledge repository for instances of the name connected with the town.

If a match is identified at least near the geographic origin, the server 101 may store the pronunciation of the name with the social networking profile, or in any other suitable location and may provide the pronunciation in response to a request by a user (e.g., when the user presses or selects the speaker button 310 of the user interface 300 of FIG. 3) (block 418). On the other hand, if a match is not identified in the knowledge repository, the server 101 may identify multimedia content including a pronunciation of the name for the provided geographic origin (block 410). The multimedia content may include music, video, audiobooks, television, movies, voice recordings, etc., all of which may be in the public domain. In some embodiments, the server 101 may instruct the search server 110 of FIG. 1 to search for multimedia content including a pronunciation of the name. If multimedia content including a localized pronunciation of the name is identified, the pronunciation is stored in the knowledge repository and connected with the provided geographic origin (block 416). The pronunciation may also be stored in the social networking profile, or any other suitable location. If the localized pronunciation of the name is not identified in the multimedia content, the server 101 may request the social networking participant to pronounce her name (block 414), and this pronunciation may be stored in the knowledge repository and/or social networking profile. Additionally, even if the server 101 identifies a pronunciation of the name from the knowledge repository or multimedia content, the social networking participant may choose to pronounce her name which may then be stored as an override to the automatically determined pronunciation.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for generating localized name pronunciation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for generating localized pronunciations of names, the method comprising:
receiving, at one or more processors, a name of a social networking participant and an indication of a geographic region of origin of the social networking participant;
identifying, by the one or more processors, multimedia content that includes an instance of the name vocalized at least near the geographic region of origin;
storing, by the one or more processors on a computer-readable medium, a reference to the vocalized name in a database record associated with the social networking participant; and
providing, by the one or more processors, the vocalized name in response to a request for pronunciation of the social networking participant's name.

2. The method of claim 1, further comprising:
receiving, at the one or more processors, a pronunciation of the name of the social networking participant from the social networking participant; and
wherein storing a reference to the vocalized name comprises storing a reference to the pronunciation of the name by the social networking participant.

3. The method of claim 1, wherein identifying multimedia content that includes an instance of the name comprises:
searching, by the one or more processors, a multi-language book database for an instance of the name, wherein the multi-language book database includes a translation into a language corresponding to the geographic region of origin;
identifying, by the one or more processors, a translated version of the name into the language corresponding the geographic region of origin; and
identifying, by the one or more processors, multimedia content that includes an instance of the translated version of the name vocalized at least near the geographic region of origin.

4. The method of claim 1, wherein the request for pronunciation of the name of the social networking participant is received via a user control on a social networking profile of the social networking participant.

5. The method of claim 1, further comprising:
storing the reference to the vocalized name in a machine-readable knowledge repository in which data that describes attributes of entities is organized according to semantic relations between the entities, each entity corresponding to a geographic region, a name, and having a reference related to a vocalized instance of the name.

6. The method of claim 5, wherein the group of entities includes a plurality of vocalized names corresponding to the geographic region, wherein at least one of the plurality of vocalized names includes at least two instances of the same vocalized name, wherein a first instance is identified from multimedia content and the second instance is received from the user.

7. The method of claim 5, further comprising:
searching, by the one or more processors, the machine-readable knowledge repository for an entity corresponding to the name of the social networking participant and the geographic region of origin of the social networking participant;
when there is a match, storing, by the one or more processors on the computer-readable medium, a reference to the vocalized name corresponding to the entity in the database record associated with the social networking participant; and
when there is no match, identifying multimedia content that includes an instance of the name vocalized at least near the geographic region of origin.

8. The method of claim 1, wherein receiving an indication of a geographic region of origin of the social networking participant comprises at least one of:
receiving an indication of a birthplace or residence of the social networking participant from a social networking profile;
receiving a global positioning system (GPS) location of a mobile device of the social networking participant; or
receiving the indication of the geographic region of origin from the social networking participant.

9. The method of claim 1, wherein the multimedia content includes at least one of: music, video, audiobooks, television, movies, or voice recordings.

10. A computing device comprising:
a machine-readable knowledge repository in which data that describes attributes of entities is organized according to semantic relations between the entities, each entity corresponding to a geographic region and a name and having a reference related to a vocalized instance of the name;
one or more processors;
a non-transitory computer-readable medium storing thereon instructions that, when executed by the one or more processors, cause the computing device to:
receive a name of a social networking participant and an indication of a geographic region of origin of the social networking participant;
identify multimedia content that includes an instance of the name vocalized at least near the geographic region of origin;
store a reference to the vocalized name in a database record of the machine-readable knowledge repository associated with the social networking participant; and
provide the vocalized name in response to a request for pronunciation of the social networking participant's name.

11. The computing device of claim 10, wherein the instructions further cause the computing device to:
search the machine-readable knowledge repository for an entity corresponding to the name of the social networking participant and the geographic region of origin of the social networking participant; and
when there is a match, provide the vocalized name corresponding to the entity.

12. The computing device of claim 11, wherein the instructions cause the computing device to identify multimedia content that includes an instance of the name vocalized at least near the geographic region of origin when there is no match in the machine-readable knowledge repository.

13. The computing device of claim 10, wherein at least some of the entities in the machine-readable knowledge repository correspond to the geographic region or origin at varying levels of detail.

14. The computing device of claim 13, wherein the at least some of the entities correspond to at least one of: a country, a continent, a state, a city, or a town.

15. The computing device of claim 10, wherein the instructions further cause the computing device to:
receive a pronunciation of the name of the social networking participant from the social networking participant; and
store a reference to the pronunciation of the name in the database record of the machine-readable knowledge repository associated with the social networking participant.

16. The computing device of claim 10, wherein to identify multimedia content that includes an instance of the name the instructions cause the computing device to:
search a multi-language book database for an instance of the name, wherein the multi-language book database includes a translation into a language corresponding to the geographic region of origin;
identify a translated version of the name into the language corresponding the geographic region of origin; and
identify multimedia content that includes an instance of the translated version of the name vocalized at least near the geographic region of origin.

17. A client device comprising:
an audio speaker;
a user interface including a user control for requesting pronunciation of a name displayed on the user interface;
one or more processors coupled to the audio speaker and the user interface; and
a non-transitory computer-readable memory coupled to the one or more processors and storing thereon instructions that, when executed by the one or more processors, cause the client device to:
transmit a name of a social networking participant and a request for pronunciation of the name of the social networking participant, via the user control, to a server device;
obtain an instance of the name vocalized at least near a geographic region of origin of the social networking participant from the server device; and
provide the vocalized name via the audio speaker.

18. The client device of claim 17, wherein to obtain an instance of the name vocalized at least near the geographic region of origin of the social networking participant, the instructions cause the computing device to:
obtain a pronunciation of the name by the social networking participant.

19. The client device of claim 17, wherein to obtain an instance of the name vocalized at least near the geographic region of origin of the social networking participant, the instructions cause the computing device to:
obtain a vocalized instance of the name from a machine-readable knowledge repository in which data that describes attributes of entities is organized according to semantic relations between the entities, each entity corresponding to a geographic region, a name, and having a reference related to a vocalized instance of the name.

20. The client device of claim 17, wherein the user interface is a user interface for a social networking profile.
